(19) United States
(12) Patent Application Publication
(10) Pub. No.: US 2026/0249745 A1
(43) Pub. Date: Aug. 27, 2026

(54) Method for Controlling Stack and Battery Output and Apparatus Therefor

(71) Applicants: Hyundai Motor Company, Seoul (KR); Kia Corporation, Seoul (KR)

(72) Inventor: Dong Kwan Lee, Hwaseong-Si (KR)

(21) Appl. No.: 19/325,126

(22) Filed: Sep. 10, 2025

(30) Foreign Application Priority Data
Feb. 24, 2025 (KR) 10-2025-0023814

(51) Int. Cl. B60L 58/40; B60L 50/75; B60L 58/13; B60L 58/31; H01M 8/04225; H01M 8/04228; H01M 8/04537; H01M 8/04858; H01M 8/04992; H01M 10/44; H01M 16/00

(52) U.S. Cl. CPC B60L 58/40; B60L 50/75; B60L 58/13; B60L 58/31; H01M 8/04225; H01M 8/04228; H01M 8/04626; H01M 8/0488; H01M 8/0494; H01M 8/04992; H01M 10/44; H01M 16/006; B60L 2240/547; B60L 2240/62; B60L 2240/68; H01M 2220/20; H01M 2250/20; H01M 2250/402

(57) ABSTRACT

A method for controlling a stack and battery output to improve durability of a fuel cell stack and an apparatus therefor. A method for distributing an output in a vehicle fuel cell system including a fuel cell (FC) stack and a high voltage battery includes collecting information about a driving route to a destination and traffic congestion information for each road section corresponding to the driving route, dividing the driving route into a first section and a second section based on the traffic congestion information for each road section, and applying different output distribution strategies to the first section and the second section.

### CROSS-REFERENCE TO RELATED APPLICATION

This application claims the benefit of priority to Korean Patent Application No. 10-2025-0023814, filed in the Korean Intellectual Property Office on Feb. 24, 2025, the entire contents of which are incorporated herein by reference.

### TECHNICAL FIELD

The present disclosure relates to a fuel cell vehicle system, and more particularly, relates to technologies for adaptively distributing a stack and battery output depending on a driving area and a driving environment of a vehicle.

### BACKGROUND

The matters described in this Background section are only for enhancement of understanding of the background of the disclosure, and should not be taken as acknowledgment that they correspond to prior art already known to those skilled in the art.

Major economies are seeking ways to expand electricity production using renewable energy rather than fossil energy.

A green energy system is a system which uses energy obtained via renewable energy, such as wind power, hydro power, tidal power, or solar power as electric energy and hydrogen energy.

Green hydrogen may be considered as the ultimate eco-friendly energy as there is no greenhouse gas emissions from the production stage. Hydrogen which is merging as globe dimensional alternative energy is roughly divided into grey hydrogen, blue hydrogen, and green hydrogen according to its production scheme.

A hydrogen fuel-based electric vehicle may provide a long driving distance using a fast charging time and one hydrogen charging due to higher energy density than a general high voltage battery-based electric vehicle.

A fuel cell vehicle may differentially distribute the amount of output to a fuel cell and a battery with regard to a stack state, a battery state, and the like to generate an output suitable for a driver's intention.

An output distribution ratio between the fuel cell and the battery may be pre-mapped according to a required vehicle output and the amount needed according to state of charge (SoC) regulation for output distribution.

However, the centralized application of the output distribution ratio may not be practical or optimal in all driving areas or all stack states and may cause conservative battery use and unnecessary stack use depending on a driving environment, thus not adequately considering stack durability.

Even when the required output of a vehicle-stage load is absent or very small, a fuel cell stack may still be required to generate an output above a certain threshold level depending on a voltage command upper limit restriction value. Subsequently, the real output of the fuel cell may exceed an output corresponding to a fuel cell output command. In such cases, the fuel cell stack may be forcibly turned off via fuel-cell stop (FcStop) control to prevent battery over-charging and unnecessary energy waste.

However, the standardized FcStop condition may cause unnecessary stack ON/OFF depending on a driving situation, which may adversely affect stack durability and a large output is required to operate an air compressor again to restart the stopped stack. Such unnecessary stack ON/OFF events also adversely affect vehicle fuel efficiency.

### SUMMARY

The present disclosure has been made to solve the above-mentioned problems.

According to the present disclosure, a method performed by an apparatus of a vehicle, the method may comprise, obtaining information about, a driving route of the vehicle to a destination, and traffic congestion information for each of a plurality of road segments, wherein the plurality of road segments are associated with the driving route, dividing, based on the traffic congestion information, the plurality of road segments into a first section and a second section, generating a signal indicating a first output distribution strategy for the first section and a second output distribution strategy for the second section, and controlling, based on the signal, operation of a fuel cell stack of the vehicle and operation of a battery of the vehicle.

The method, wherein the first output distribution strategy may comprise, a fuel cell (FC) ON/OFF strategy defining ON/OFF switching logic of the fuel cell stack, a power output distribution strategy of the fuel cell stack and the battery based on a required load output of the vehicle and an SoC state of the battery, and a voltage upper/lower limit restriction strategy defining voltage upper/lower limit restriction logic of the fuel cell stack.

The method, wherein the ON/OFF switching logic may comprise, a first logic for generating a first fuel cell stop (FcStop) command for switching to an FC ON state, based on, an SoC of the battery being less than a first reference value in an FC OFF state, the required load output being greater than a battery dischargeable output limit value, and a duration of the FC OFF state being greater than a threshold FC OFF duration, and a second logic for generating a second FcStop command for switching to the FC OFF state based on the SoC of the battery being greater than a second reference value in the FC ON state.

The method, wherein the voltage upper/lower limit restriction logic may comprise, a first logic for adjusting a voltage upper limit restriction value of the fuel cell stack to a stack voltage corresponding to a first cell voltage, and a second logic for changing a stack voltage corresponding to a default cell voltage to a stack voltage corresponding to a second cell voltage, based on a voltage lower limit change condition being satisfied, wherein the second cell voltage is less than the default cell voltage, and wherein the first cell voltage is greater than the default cell voltage.

The method, wherein the voltage lower limit change condition is satisfied based on at least one of, a first condition in which the SoC of the battery is less than first SoC criteria, a second condition in which a discharge output limit value of the battery is less than a first battery discharge output reference value, or a third condition in which a first value is greater than a second value, wherein the first value is a difference between a default target output value and a real FC output, wherein the second value is obtained by subtracting a battery output distribution value and a margin value from a battery discharge output limit value, and wherein a voltage command is limited to a voltage lower limit value.

According to the present disclosure, an apparatus of a vehicle, the apparatus may comprise, a processor, and a memory storing at least one instruction that, when executed by the processor communicating with the memory, is configured to cause the apparatus to, obtain information about, a driving route of the vehicle to a destination, and traffic congestion information for each of a plurality of road segments, wherein the plurality of road segments are associated with the driving route, divide, based on the traffic congestion information, the plurality of road segments into a first section and a second section, generate a signal indicating a first output distribution strategy for the first section and a second output distribution strategy for the second section, and control, based on the signal, operation of a fuel cell stack of the vehicle and operation of a battery of the vehicle.

The apparatus, wherein the at least one instruction, when executed by the processor communicating with the memory, is configured to cause the apparatus to, for the vehicle driving in the second section that is a destination adjacent section, control ON/OFF of the fuel cell stack based on the second output distribution strategy such that a predefined default state of charge (SoC) regulation of the battery is satisfied in the second section.

The apparatus, wherein the at least one instruction, when executed by the processor communicating with the memory, is configured to cause the apparatus to, for the vehicle driving in the first section that is a destination driving section, adjust a charging/discharging range of the battery to be greater than a charging/discharging range of the battery for driving the vehicle in the second section such that an ON/OFF switching frequency of the fuel cell stack for the driving in the first section is less than an ON/OFF switching frequency of the fuel cell stack for the driving in the second section.

The apparatus, wherein the at least one instruction, when executed by the processor communicating with the memory, is configured to cause the apparatus to, based on the vehicle driving in the first section, set a target SoC regulation value of the battery to a value less than a default SoC regulation value of the battery that is set for the vehicle driving in the second section.

The apparatus, wherein the at least one instruction, when executed by the processor communicating with the memory, is configured to cause the apparatus to, determine the second section such that the predefined default SOC regulation is satisfied when the vehicle arrives at the destination, and wherein a starting point of the second section is determined as a point at which a sum of an estimated time taken for each of the plurality of road segments in the second section equals a time required to reach the predefined default SoC regulation after the vehicle entering the second section.

The apparatus, wherein the at least one instruction, when executed by the processor communicating with the memory, is configured to cause the apparatus to, obtain, via an in-vehicle communication network from a navigation system of the vehicle, the information about the driving route to the destination and the traffic congestion information.

According to the present disclosure, a vehicle may comprise, a battery, a fuel cell stack, a processor, and a memory storing at least one instruction that, when executed by the processor communicating with the memory, is configured to cause the vehicle to, obtain information about, a driving route of the vehicle to a destination, and traffic congestion information for each of a plurality of road segments, wherein the plurality of road segments are associated with the driving route, based on the traffic congestion information, classify the plurality of road segments into a first section and a second section, wherein the first section and the second section are defined based on the destination, apply, during the vehicle driving in the first section, a first output distribution configured to control ON/OFF of the fuel cell stack to reduce a switching frequency of the fuel cell stack and adjust a charging/discharging range of the battery, and apply, during the vehicle driving in the second section, a second output distribution configured to control ON/OFF of the fuel cell stack such that a state of charge (SoC) of the battery satisfies a target SoC of the battery upon the vehicle arriving at the destination.

The vehicle, wherein the at least one instruction, when executed by the processor communicating with the memory, is configured to cause the vehicle to, based on a degree of traffic congestion level in the first section, adjust the target SoC of the battery, wherein the target SoC is lowered based on the degree of traffic congestion level being high, and wherein the target SoC is raised based on the degree of traffic congestion level being low.

The vehicle, wherein the at least one instruction, when executed by the processor communicating with the memory, is configured to cause the vehicle to determine a starting point of the second section where an estimated driving time remaining to the destination equals a time required to charge the battery from a current SoC of the battery to the target SoC of the battery.

The vehicle, wherein the at least one instruction, when executed by the processor communicating with the memory, is configured to cause the vehicle to automatically execute, without driver input, a first output distribution strategy in the first section and a second output distribution strategy in the second section.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a fuel cell system;

FIG. 2 shows an example of the entire configuration of a vehicle fuel cell system;

FIG. 3 shows an example of a configuration of a vehicle fuel cell system;

FIG. 4 shows an example of a procedure of distributing a fuel cell and battery output in a fuel cell system;

FIG. 5 shows an example of a stack ON/OFF control mechanism;

FIG. 6 shows an example of a fuel cell/battery output distribution strategy based on operation area (section) classification;

FIG. 7 shows an example of a method for controlling a stack and battery output to improve durability of a fuel cell stack;

FIG. 8 shows an example of a method for controlling a stack and battery output to improve durability in a fuel cell vehicle;

FIG. 9 shows an example of control logic according to an FC ON/OFF control strategy in a destination driving section;

FIG. 10 shows an example of control logic according to a voltage upper/lower limit control strategy in a destination driving section;

FIG. 11 shows an example of voltage command upper/lower limit control logic in a destination driving section;

FIG. 12 shows an example of voltage command upper/lower limit control logic in a destination driving section;

FIG. 13 shows an exemplary output profile for describing a problem which occurs when applying an output distribution strategy;

FIG. 14 shows an exemplary output profile when applying an output distribution and FC ON/OFF strategy;

FIG. 15 shows an exemplary output profile when applying an output distribution and FC ON/OFF strategy; and

FIG. 16 shows an example computing system.

### DETAILED DESCRIPTION

Hereinafter, some examples of the present disclosure will be described in detail with reference to the accompanying drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfers driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system.

Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

In one or more examples, the autonomous driving control may incorporate road section-based adaptive fuel cell and battery output control using route and traffic information. In such configurations, the autonomous driving system may obtain a driving route to a destination and traffic congestion information for each of a plurality of road sections constituting the route, classify the road sections into a destination driving section and a destination adjacent section based on the destination, and apply different output distribution strategies for the fuel cell stack and battery during vehicle driving in each section. In the destination driving section, the system may execute a first output distribution strategy configured to control ON/OFF of the fuel cell stack to reduce a switching frequency of the fuel cell stack, adjust a charging/discharging range of the battery to be greater than a default range, and modify at least one of a voltage upper limit restriction value or a voltage lower limit restriction value of the fuel cell stack based on a state of charge (SoC) of the battery and a required load output of the vehicle. In the destination adjacent section, the system may execute a second output distribution strategy configured to control ON/OFF of the fuel cell stack such that the SoC of the battery meets a target SoC upon arrival at the destination.

The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features such as the above-described road section-based adaptive fuel cell and battery output control. One or more communication devices (e.g., a modem, a network adapter, a radio transceiver, an antenna, etc., capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on the road section-based adaptive fuel cell and battery output control.

Minimum risk maneuver (MRM) operations may also be controlled, for example, based on the road section-based adaptive fuel cell and battery output control. A minimal risk maneuver may be activated during autonomous driving of the vehicle when a driver is unable to respond to a request to intervene. During the minimal risk maneuver, one or more processors of the vehicle may control a driving operation of the vehicle for a set period of time while managing the fuel cell stack and battery outputs according to the section-based control strategy to conserve energy and maintain system stability.

Biased driving operation(s) may also be controlled, for example, based on the road section-based adaptive fuel cell and battery output control. A driving control apparatus may perform a biased driving control, such as maintaining a lateral distance offset from the lane center, while also adjusting propulsion power distribution between the fuel cell stack and battery according to the classified driving sections.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, in coordination with the road section-based adaptive fuel cell and battery output control described herein.

An operation control for autonomous driving of the vehicle may include various driving controls of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). An autonomous driving level and/or autonomous driving activation/deactivation may also be controlled, for example, based on the road section-based adaptive fuel cell and battery output control. A driving control apparatus may perform an autonomous driving level control (e.g., a change of an autonomous driving level, a change of a required user attentiveness, etc.) or cause deactivation of an autonomous driving operation while ensuring that the battery SoC and fuel cell stack operation remain optimized for the remaining route to the destination.

The present disclosure relates to techniques for improving the operational efficiency and durability of fuel cell vehicles by adaptively controlling the distribution of output between a fuel cell (FC) stack and a high voltage battery. In fuel cell vehicle systems, the ratio of output distribution between the FC stack and the battery may be predetermined. Such “one-size-fits-all” approach may lead to unnecessary energy consumption, increased ON/OFF switching of the stack, and reduced stack lifespan. According to the present disclosure, navigation and traffic information are used to divide a driving route into a “destination driving section” (e.g., most of the trip) and a “destination adjacent section” (e.g., near the end of the trip). In the destination driving section, output distribution control is applied with greater flexibility, including allowing a wider state-of-charge (SoC) range for the battery, reducing or minimizing stack ON/OFF events, and adjusting stack voltage limits to improve fuel efficiency and enhance stack durability. In the destination adjacent section, a default control strategy is applied to ensure the battery SoC reaches a target value by the time the vehicle arrives at the destination (e.g., to make sure the battery is at the right charge when the trip ends). By adaptively adjusting output distribution based on real-time driving conditions, traffic congestion, and section classification, the disclosed techniques may improve overall energy efficiency, maintain battery readiness for subsequent driving, and extend the operational life of the FC stack.

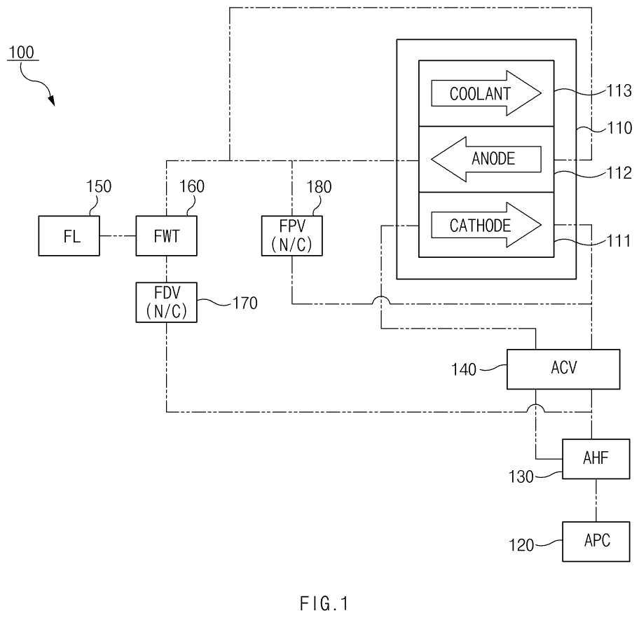

Hereinafter, examples of the present disclosure will be described in detail with reference to FIGS. 1 to 16.

FIG. 1 shows an example of a fuel cell system according to an example of the present disclosure.

As shown in FIG. 1, a fuel cell system 100 according to an example of the present disclosure may supply oxygen (or air) and hydrogen, which are fuel of a fuel cell stack 110, to a cathode 111 and an anode 112, which are membrane electrode assemblies (e.g., proton exchange membrane assemblies, polymer electrolyte membrane assemblies, or similar structures, etc.), via a flow path of a bipolar plate, respectively. In other words, the oxygen (or air) may be supplied to the cathode 111 in the fuel cell stack 110 and the hydrogen may be supplied to the anode 112 in the fuel cell stack 110.

Furthermore, a coolant 113 stored in a refrigerant storage (not shown) may be supplied into the fuel cell stack 110 via a cooling line (e.g., a liquid cooling loop, a glycol-water mixture line, or another closed-loop coolant circuit, etc.).

First of all, an air humidifier (AHF) 130 for maintaining humidity of important oxygen (or air) in the reaction of the fuel cell stack 110 and valves for controlling supply of oxygen (or air), for example, an air cut-off valve (ACV) 140, an air pressure control valve (APC) (or a driving pressure control value) 120, or a driving pressure control valve, etc., may be arranged on the side of the cathode 111.

Herein, the AHF 130 may supply moisture at the oxygen (or air) inlet side. The oxygen (or air) receiving the moisture moves along the flow path in the fuel cell stack 110 and reacts with hydrogen to generate water (e.g., liquid water droplets, vapor, or mist, etc.). Herein, because the water generated by the electrochemical reaction interferes with flow of oxygen and hydrogen, there is a need to remove the water from the fuel cell stack 110.

Thus, at least one of a fuel-line purge valve (FPV) 180 for discharging impurities and condensate in the fuel cell stack 110, a fuel-line water trap (FWT) 160, a fuel-line level sensor (FL) 150, or a fuel-line drain valve (FDV) 170 may be composed on the side of the anode 112. In detail, the FPV 180 may discharge impurities generated in the anode 112 in the fuel cell stack 110 (e.g., nitrogen, inert gases, or particulate contaminants, etc.). The FWT 160 may collect the condensate generated in the anode 112 in the fuel cell stack 110 by a certain water level and may discharge the collected condensate to the cathode 111 via the FDV 170.

The APC 120 may perform a function of controlling an angle of a valve disk during driving and adjusting the pressure within a flow path of an air supply system (or an oxidizing gas supply system) (e.g., to manage transient response, balance airflow across cells, or prevent compressor surge, etc.) to improve efficiency of the fuel cell stack 110.

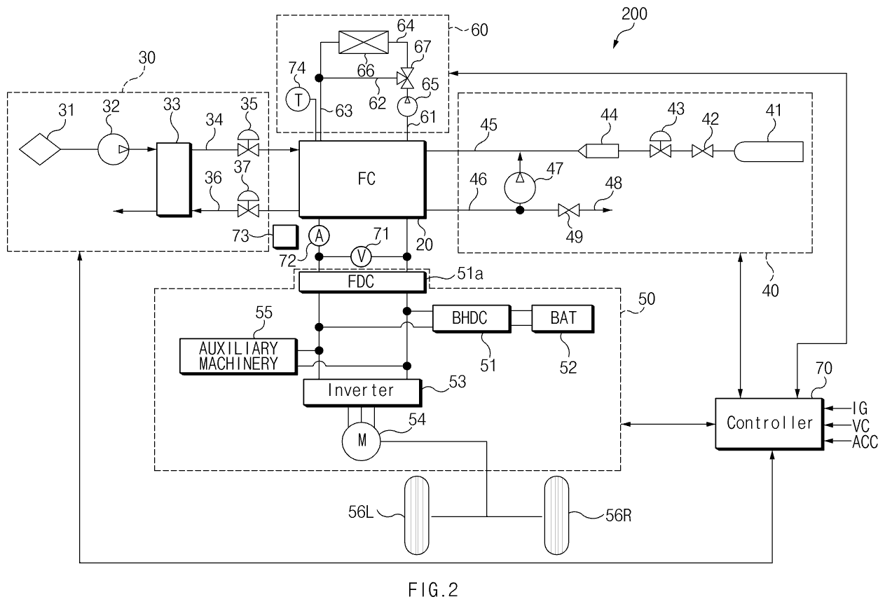

FIG. 2 shows an example of the entire configuration of a vehicle fuel cell system according to an example of the present disclosure.

A vehicle fuel cell system 200 may function as an on-board power system installed in a fuel cell vehicle and may be configured to include a fuel cell stack 20 for receiving reaction gas (or fuel gas or oxidizing gas) and generating electricity, an oxidizing gas supply system 30 for supplying air as oxidizing gas to the fuel cell stack 20, a fuel gas supply system 40 for supplying hydrogen gas as fuel gas to the fuel cell stack 20, a power system 50 for controlling charging and discharging of power, a cooling system 60 for cooling the fuel cell stack 20, and a controller (ECU) 70 for controlling the entire system (e.g., managing startup/shutdown, controlling stack temperature, or balancing cell voltages, etc.).

The fuel cell stack 20 may be a solid polymer electrolyte cell stack formed by laminating a plurality of cells in series. Oxidation reaction may be performed at the anode electrode of the fuel cell stack 20 and reduction reaction may be performed at the cathode electrode (e.g., oxygen reduction, proton conduction through the membrane, and water formation at the cathode, etc.).

A voltage sensor 71 for detecting an output voltage of the fuel cell stack 20, a current sensor 72 for detecting a generation current, and a cell voltage sensor 73 for detecting a cell voltage may be installed on the fuel cell stack 20 (e.g., for diagnostic purposes, performance monitoring, or degradation tracking, etc.).

The oxidizing gas supply system 30 may include an oxidizing gas passage 34 in which an oxidizing gas supplied to the cathode electrode of the fuel cell stack 20 flows and an oxidation off-gas passage 36 in which an oxidation off-gas discharged from the fuel cell stack 20 flows. An air compressor 32 for introducing and compressing an oxidizing gas from the atmosphere via a filter 31, an air humidifier 33 for humidifying an oxidizing gas supplied to the cathode electrode of the fuel cell stack 20, and a throttle valve 35 for adjusting the amount of oxidizing gas supply may be installed on the oxidizing gas passage 34. A back pressure control valve 37 for adjusting oxidizing gas supply pressure and the air humidifier 33 for exchanging moisture between an oxidizing gas (or a dry gas) and an oxidation off-gas (or a wet gas) may be installed on the oxidation off-gas passage 36 (e.g., to recover humidity, improve stack hydration, or prevent cathode flooding, etc.).

The fuel gas supply system 40 may include a fuel gas supply source 41, a fuel gas passage 45 in which a fuel gas supplied from the fuel gas supply source 41 to the anode electrode of the fuel cell stack 20 flows, a circulation passage 46 for returning a fuel-off gas discharged from the fuel cell stack 20 to the fuel gas passage 45, a circulation pump 47 for pumping the fuel-off gas in the circulation passage 46 to the fuel gas passage 45, and an exhaust and drain passage 48 branching to the circulation passage 46 (e.g., for moisture removal, impurity purging, or system pressure relief, etc.).

The fuel gas supply source 41 may be composed of, for example, a high-pressure hydrogen tank, a hydrogen absorption alloy, a liquid hydrogen storage system, or a cryo-compressed hydrogen vessel, etc., and may store a high-pressure (e.g., 35 MPa to 70 MPa) hydrogen gas. When a cut-off valve 42 is open, the fuel gas leaks from the fuel gas supply source 41 to the fuel gas passage 45. The fuel gas may be decompressed up to, for example, about 200 kPa by a regulator 43 or an injector 44 to be supplied to the fuel cell stack 20.

Furthermore, the fuel gas supply source 41 may be composed of a reformer for generating hydrogen-rich reformed gas from hydrocarbon fuel (e.g., methane, natural gas, methanol, or gasoline, etc.) and a high-pressure gas tank for pressurizing the reformed gas generated by the reformer to a high-pressure state.

The regulator 43 may be a device for adjusting upstream pressure (or primary pressure) to predetermined secondary pressure and may be composed of, for example, a mechanical decompression valve for decompressing the primary pressure (e.g., spring-loaded valve, dome-loaded valve, or diaphragm-controlled valve, etc.). The mechanical decompression valve may have a housing in which a back pressure chamber and a pressure control chamber are formed by separating a diaphragm and may have a configuration for decompressing primary pressure to certain secondary pressure to be secondary pressure in the pressure control chamber by back pressure in the back pressure chamber.

The injector 44 may be an electronically actuated open/close valve for directly driving a valve body at a certain driving period using an electronic driving force and separating the valve body from a valve seat to adjust a gas flow rate or gas pressure (e.g., to meter hydrogen delivery, prevent oversupply, or enable rapid flow adjustments, etc.). The injector 44 may include a valve seat with an injection hole for injecting gas fuel, such as fuel gas and may include a nozzle body for supplying and guiding the gas fuel to the injection hole and a valve body movably accommodated in an axis direction (or a gas flow direction) within the nozzle body for opening and closing the injection hole.

An exhaust and drain valve 49 may be disposed on the exhaust and drain passage 48. The exhaust and drain valve 49 may operate depending on a command from a controller 70 to exhaust fuel-off gas and moisture, which include impurities in the circulation passage 46, to the outside (e.g., nitrogen buildup, water accumulation, or particulate contamination, etc.). As density of impurities in the fuel-off gas in the circulation passage 46 drops due to an open valve of the exhaust and drain valve 49, hydrogen density in the fuel-off gas circulating in a circulation system may rise.

The fuel-off gas exhausted via the exhaust and drain valve 49 is mixed with the oxidation off-gas (e.g., moist exhaust air or unused oxidant gas, etc.) which flows in the oxidation off-gas passage 36 and is diluted by a dilutor (not shown). The circulation pump 47 may circulate and supply the fuel-off gas in the circulation system to the fuel cell stack 20 via motor-driven pumping (e.g., electric motor drive, hydraulic drive, or belt-driven mechanism, etc.).

The power system 50 may include a fuel-cell DC-DC converter (FDC) 51a, a bidirectional high voltage DC-DC converter (BHDC) 51b, a high voltage battery 52, a traction inverter 53, a traction motor 54, and auxiliary machinery 55. The FDC 51a may play a role in controlling an output voltage of the fuel cell stack 20 and may be a bidirectional voltage converter for converting (e.g., boosting or bucking) an output voltage input to a primary side (or an input side: the side of the fuel cell stack 20) into a voltage value different from the primary side and outputting the voltage value to a secondary side (or an output side: the side of the inverter 53) and vice versa (e.g., power flow during regenerative braking or startup support, etc.). An operation point (I, V) of the fuel cell stack 20 may be controlled by voltage conversion control by the FDC 51a.

The BHDC 51b may play a role in controlling an input voltage of the inverter 53 and may include, but is not limited to, the same or similar circuit configuration to the FDC 51a. The circuit configuration of the BHDC 51b may adopt all configurations capable of controlling the input voltage of the inverter 53 (e.g., isolated topology, non-isolated topology, or multi-phase interleaved design, etc.). The BHDC 51b may convert power generated by the fuel cell stack 20 to charge the high voltage battery 52 (e.g., during surplus power generation) or may convert power charged in the high voltage battery 52 to supply the power to the traction inverter 53 and the auxiliary machinery 55 (e.g., for vehicle launch, hill climbing, or acceleration assist, etc.).

The high voltage battery 52 may serve as a storage source of surplus power, regenerative energy storage source upon regenerative breaking, or an energy buffer upon load fluctuation accompanied by acceleration or deceleration of the fuel cell vehicle. A secondary battery, such as a nickel-cadmium battery, a nickel-hydrogen battery, or a lithium secondary battery (e.g., lithium-ion, lithium-polymer, or lithium-titanate, etc.), may be suitable for the high voltage battery 52.

The traction inverter 53 may be, for example, a PWM inverter driven by pulse width modulation and may convert a DC voltage output from the fuel cell stack 20 or the high voltage battery 52 into a three-phase AC voltage depending on a control command from the controller 70 to control rotation torque of the traction motor 54 (e.g., for forward drive, reverse drive, or regenerative braking torque control, etc.). The traction motor 54 may be a motor (e.g., a three-phase AC motor, permanent magnet synchronous motor, or switched reluctance motor, etc.) for driving wheels 56L and 56R and may configure a power source of the fuel cell vehicle.

The auxiliary machinery 55 may collectively refer to each motor disposed in each unit of the fuel cell system 10 (e.g., blower motors, coolant pumps, or recirculation pumps, etc.), inverters for driving these motors, or various on-board auxiliary machinery (e.g., an air compressor, an injector, a coolant circulation pump, a radiator, a radiator fan, or a vacuum pump, etc.).

The cooling system 60 may include refrigerant passages 61, 62, 63, and 64 for allowing the refrigerant which circulates in the fuel cell stack 20 to flow, a circulation pump 65 for pumping the refrigerant (e.g., an electric coolant pump, mechanically driven pump, or variable-speed pump, etc.), a radiator 66 for performing heat exchange between the refrigerant and external air (e.g., ambient airflow while driving, forced airflow from a radiator fan, or ducted airflow, etc.), a three-way valve 67 for switching a circulation path of the refrigerant, and a temperature sensor 74 for detecting a temperature of the fuel cell stack 20. Opening and closing of the three-way valve 67 may be controlled such that the refrigerant flowing out from the fuel cell stack 20 flows in the refrigerant passages 61 and 64, is cooled in the radiator 66, and flows in the refrigerant passage 63 to be introduced into the fuel cell stack 20 again, upon normal driving after warm-up driving is completed. Meanwhile, opening and closing of the three-way valve 67 may be controlled such that the refrigerant flowing out from the fuel cell stack 20 flows in the refrigerant passages 61, 62, and 63 and is introduced into the fuel cell stack 20 again, upon warm-up driving immediately after the system starts (e.g., on a cold morning, after prolonged parking in winter conditions, or after system maintenance, etc.).

The controller 70 may be a computer system including a CPU, a ROM, a RAM, an input/output interface, and the like and may function as a control means for controlling each unit (e.g., the oxidizing gas supply system 30, the fuel gas supply system 40, the power system 50, and the cooling system 60) of the fuel cell system 10. For example, when receiving a start signal IG output from an ignition switch, the controller 70 may initiate driving of the fuel cell system 10 and may calculate required power of the entire system based on an accelerator opening degree signal ACC output from an accelerator sensor (e.g., pedal position sensor) or a vehicle speed signal VC output from a vehicle speed sensor (e.g., wheel speed sensor, GPS-based speed detection, or transmission output speed sensor, etc.).

The required power of the entire system may be the sum of power required for vehicle driving and auxiliary power. The auxiliary power may include power consumed by on-board auxiliary machinery (e.g., an air humidifier, an air compressor, a hydrogen pump, a coolant circulation pump, a radiator fan, or a vacuum pump, etc.), power consumed by a device (e.g., a transmission actuator, a wheel control device, an electric steering device, an adaptive suspension, and the like) necessary for vehicle driving, power consumed by a device (e.g., an air conditioning device, a cabin heating unit, interior/exterior lighting fixtures, an audio, an infotainment system, or a navigation display, etc.) arranged in a passenger space, or the like.

Furthermore, the controller 70 may determine distribution of output power of each of the fuel cell stack 20 and the high voltage battery 52, may calculate a generation command value, and may control the oxidizing gas supply system 30 and the fuel gas supply system 40, such that the amount of generation of the fuel cell stack 20 meets required amount of generation P_{req}. Furthermore, the controller 70 may control the FDC 51a or the like to control an operation point of the fuel cell stack 20. The controller 70 may output, for example, each of U-, V-, and W-phase AC voltage command values as switching commands to the traction inverter 53, such that a target vehicle speed according to an accelerator open degree is obtained and may control output torque and revolutions per minute (RPM) of the traction motor 54 (e.g., for rapid acceleration, steady cruising, regenerative braking, or hill climbing, etc.).

The fuel cell and battery output distribution strategy of the controller 70 (e.g., dynamic SoC-based control, load-adaptive switching, or section-specific output optimization, etc.) according to the present disclosure will be described in detail with reference to the description of drawings which will be described below.

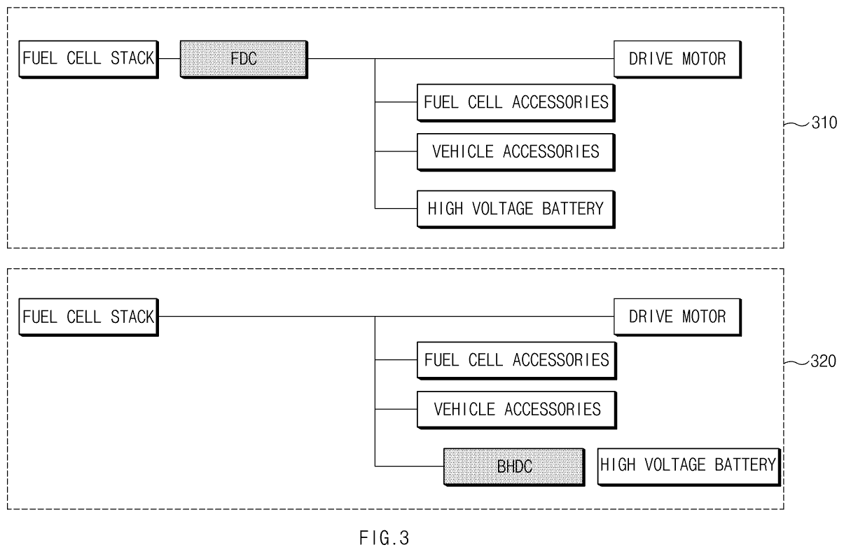

FIG. 3 shows an example of a configuration of a vehicle fuel cell system according to an example of the present disclosure.

As shown in FIG. 3, the vehicle fuel cell system may be divided into two types according to a position of a DC-DC converter (e.g., whether the DC-DC converter is placed between the fuel cell stack and the motor drive system, or between the fuel cell stack and the high-voltage battery, etc.).

The vehicle fuel cell system shown in reference numeral 310 may be configured to include a fuel cell stack, an FDC, fuel cell accessories (e.g., air compressor, hydrogen pump, humidifier, coolant pump, etc.), vehicle accessories, a high voltage battery, and a drive motor.

The vehicle fuel cell system shown in reference numeral 320 may be configured to include a fuel cell stack, fuel cell accessories, vehicle accessories, a BHDC, a high voltage battery, and a drive motor.

A description will be given of an example of the vehicle fuel cell system in reference numeral 320 in an example below. However, as described in FIG. 2, it should be noted that the vehicle fuel cell system may be configured to include both the FDC and the BHDC (e.g., to support bidirectional energy flow between the battery and the motor, or to improve voltage conversion flexibility, etc.).

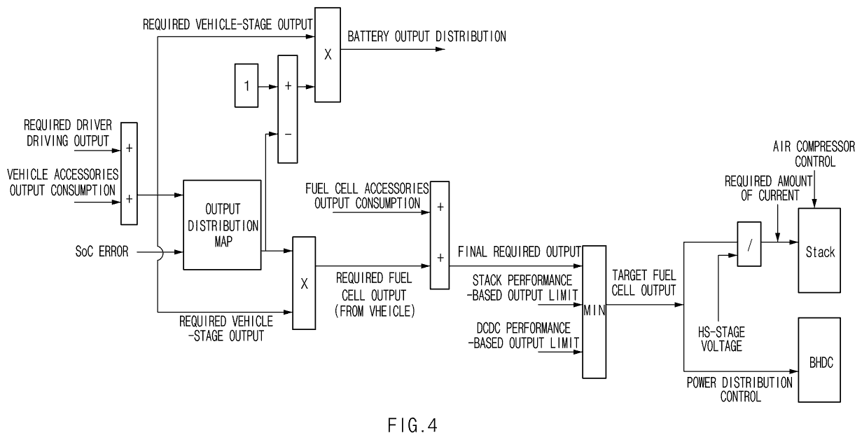

FIG. 4 shows an example of a procedure of distributing a fuel cell and battery output in a fuel cell system.

Referring to FIG. 4, an output distribution ratio between a fuel cell and a battery is determined based on an accelerator-based required driver driving output, vehicle accessories output consumption, a battery SoC error, (i.e., a difference between a target SoC and a real SoC), road grade, ambient temperature, regenerative braking availability, and the like.

Thereafter, the output distribution ratio is multiplied by a required vehicle-stage output to determine a required fuel cell output and fuel cell accessories output consumption (e.g., air compressor load, coolant pump load, hydrogen pump load, etc.) is added to the required fuel cell output to determine a final required output.

The target fuel cell output is determined as a minimum value based on the final required output, a stack performance-based output limit (e.g., maximum sustainable power at given temperature and humidity), and a DCDC performance-based output limit (e.g., maximum allowable conversion efficiency or heat load).

The target fuel cell output is delivered to an air compressor controller and a voltage command determination controller. The air compressor controller determines RPM of the air compressor (e.g., increasing RPM for higher load demand, or reducing RPM for idle operation) to generate the target output. The voltage command determination controller determines a BHDC voltage command to have an output corresponding to the battery output distribution ratio.

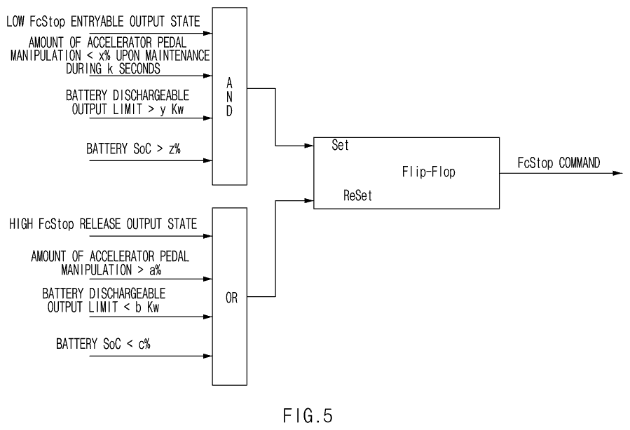

FIG. 5 shows an example of a stack ON/OFF control mechanism.

Referring to FIG. 5, if there is no acceleration will of a driver (e.g., during coasting, idling at a stoplight, or creeping in traffic) with regard to the magnitude of a required fuel cell output (from a vehicle), a battery dischargeable output limit value, a battery SoC remaining capacity, the amount of accelerator pedal manipulation, and the fuel cell output command is sufficiently low, and the battery discharge output is sufficient, an FcStop command is set and the stack is off.

On the other hand, if there is an acceleration will of the driver (e.g., sudden pedal press for overtaking or merging) with regard to the amount of accelerator pedal manipulation, the fuel cell output command is sufficiently high, or the battery dischargeable output is insufficient, the FcStop command is reset and the stack is on.

A low FcStop enterable output state in FIG. 5 may be defined by Equation 1 below and a high FcStop release output state may be defined by Equation 2 below.

Integration of (required fuel cell output (from vehicle)−high FcStop release output reference value (MAP))>FcStop release integration energy (MAP) Equation 1

Integration of (low FcStop entry able output reference value (MAP)−required fuel cell output (from vehicle))>FcStop enterable integration energy (MAP) Equation 2

The fuel cell/battery output distribution mechanism and the stack ON/OFF control mechanism according to FIGS. 4 and 5 described above have a characteristic for determining a centralized output distribution ratio and thus have a problem in which it is not considered although it is possible to ensure stack durability depending on the driving situation and the battery state. Furthermore, stack OFF is performed even though it is advantageous to continuously drive according to stack ON due to the centralized FcStop strategy or stack ON is performed even though stack OFF is able to be kept. In other words, frequent accelerator ON/OFF, such as a road congestion situation or a parking situation, stop-and-go urban traffic, or low-speed maneuvering, etc., may cause stack ON/OFF.

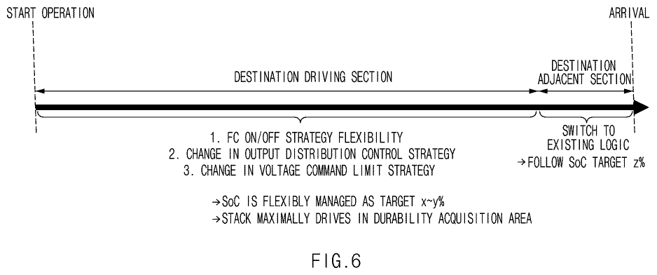

FIG. 6 shows an example of a fuel cell/battery output distribution strategy based on operation area (section) classification according to an example of the present disclosure.

Referring to FIG. 6, an operation section may be roughly classified as a “destination driving section” or a “destination adjacent section” based on navigation destination information and road congestion situation information (e.g., heavy traffic on arterial roads, free-flowing expressway segments, or stop-and-go city streets).

A battery output may be flexibly used via FC ON/OFF strategy flexibility, a change in output distribution strategy, and a change in voltage command limit strategy in the destination driving section. For example, an SoC may be flexibly managed as x %~y % and a stack may be controlled to maximally drive in a durability acquisition area (e.g., moderate load operation to reduce membrane wear, maintaining temperature and humidity within optimal ranges). Herein, x % to y % of the SoC may be, but is not limited to, 30% to 80%. x % to y % may vary with specifications and a use environment of the fuel cell system (e.g., hot climate, mountainous terrain, or cold-weather operation).

On the other hand, it may be controlled to switch to an existing control strategy, that is, a default control strategy in the destination adjacent section to comply with target battery SoC z % and perform output distribution. Herein, z may be set to a value between x and y. As an example, z % may be, but is not limited to 60%. z % may vary with the specifications and the use environment of the fuel cell system (e.g., to ensure sufficient charge for parking maneuvers, accessory operation, or immediate restart after short stops).

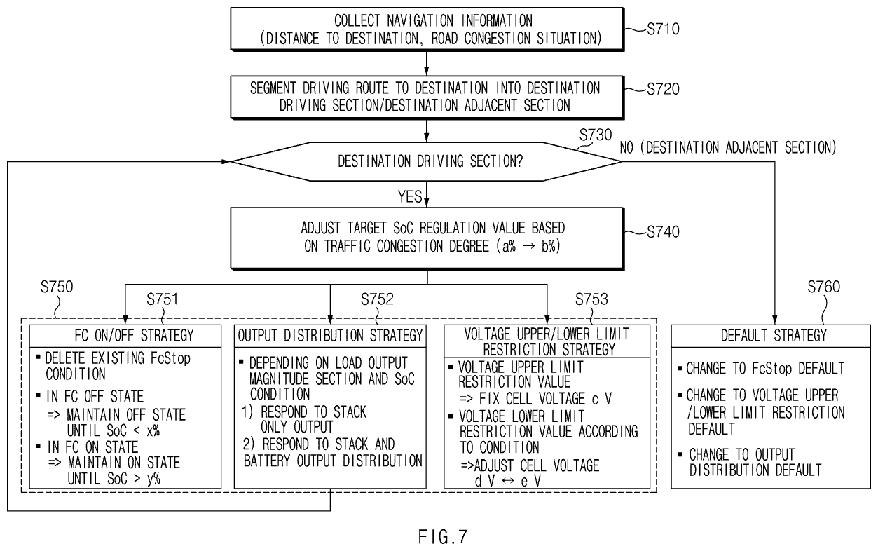

FIG. 7 shows an example of a method for controlling a stack and battery output to improve durability of a fuel cell stack according to an example of the present disclosure.

In detail, the method of FIG. 7 may be performed by the above-mentioned controller 70 of FIG. 2. The controller 70 may interwork with audio video navigation (AVN) over an inter-vehicle network to collect route setting information to a destination and traffic situation information corresponding to the route setting. As another example, a vehicle may be provided with a vehicle terminal. The vehicle terminal may receive real-time traffic situation information from an external server, for example, a vehicle telematics server, a real-time road traffic information providing server, or the like over a wireless network and may provide the controller 70 with the real-time traffic situation information (e.g., traffic jams, lane closures, weather-related slowdowns). When the vehicle operation starts, the battery SoC may have a predetermined default target value, for example, SoC 60% or more.

Referring to FIG. 7, in S710, the controller 70 may collect navigation information. Herein, the navigation information may include route setting information to a destination and traffic situation information corresponding to the set destination route. As an example, the traffic situation information may include, but is not limited to, congestion information for each road section, accident information, construction information, weather advisories, special event road closures, or the like.

In S720, the controller 70 may segment the route to the destination into a destination driving section and a destination adjacent section. As an example, the driving section segmentation may be basically divided based on a charging time required to meet minimum SoC regulation when a vehicle arrives at the destination, and this is only an example. The driving section segmentation may be divided further considering an estimated driving time which remains to the destination, fuel efficiency considering a traffic situation, and the like as well as the remaining distance (e.g., increasing battery reserve for uphill final segments, or reducing reserve for downhill arrival routes with expected regenerative braking).

In S730, the controller 70 may determine whether the current location of the vehicle is in a driving section.

When the current location of the vehicle is in the driving section as a result of the determination, in S740, the controller 70 may identify a traffic congestion degree of a road on which the vehicle is driving and may determine and adjust a target SoC regulation value based on the identified traffic congestion degree. As an example, the SoC regulation value may be set to any one of values between at least a % and up to b % based on the traffic congestion degree in the driving section. Herein, a % to b % of the SoC may be, but is not limited to, 30% to 80%. a % to b % may vary with specifications and a use environment of the fuel cell system (e.g., long-distance highway cruising, city stop-and-go operation, or mixed rural driving).

As an example, the controller 70 may adjust the target SoC regulation value to a minimum configurable value, 40%, when the traffic congestion degree has the highest level, and may adjust the target SoC regulation value to a maximum configurable value, 60%, when the traffic congestion degree has the lowest level. As another example, the controller 70 may determine that the road is in a congestion state to determine the target SoC regulation value as the minimum value, 40%, when an average vehicle speed predicted based on the traffic situation information is less than a certain “vehicle speed slowness reference value CAL”, and may determine that there is no road congestion to determine the target SoC regulation value as the maximum value, 60%, when the predicted average vehicle speed is greater than a “vehicle speed quickness reference value CAL”. When there is much road congestion, because there are a few cases in which a large output is required, such as acceleration (e.g., short bursts to change lanes or move in stop-and-go traffic), the controller 70 may manage the target SoC regulation value to be low as 40%. On the other hand, when there is no road congestion, there is a need for output response preparation according to a driving will of the driver, such as vehicle acceleration (e.g., overtaking on a highway, merging onto a freeway), anytime. Thus, the controller 70 may set the target SoC regulation value to 60% and may manage the target SoC regulation value not to have an influence on high-speed driving.

In S750, the controller 70 may change a default strategy to a predefined strategy in response to the destination driving section. Herein, the strategy changed in response to the driving section may include an FC ON/OFF strategy S751, an output distribution strategy S752, and a voltage upper/lower limit restriction strategy S753 (e.g., applying aggressive fuel cell usage in long highway stretches and more battery-based driving in urban congestion).

As an example, the FC ON/OFF strategy S751 may change to delete (or ignore) an existing FcStop condition, maintain an OFF state until the SoC enters less than x % in an FC OFF state, and maintain an ON state until the SoC enters more than y % in an FC ON state. Herein, y is greater than x. As an example, when the road congestion continues, the number of times the vehicle stops increases. In this case, although not maintaining a high SoC due to the set target SoC regulation value, the controller 70 may maintain an upper limit voltage command value up to the SoC reference value y % which switches to the FC OFF mode and may charge the SoC via the fuel cell output. For example, when x % of the SoC may be 30% and y % may be 80%, the system may run the stack in steady mode on an open expressway but switch it OFF for short urban hops to reduce wear. x % and y % may vary with specifications and a use environment of the fuel cell system.

As an example, the output distribution strategy S752 may change to distribute an output to only the stack or distribute an output to the stack and the battery, depending on the load output magnitude section and the SoC condition. Herein, the load output (or required load output) magnitude may refer to a total amount of output required by all loads provided in the vehicle. As an example, the load output magnitude interval may be predefined as an upper/middle/lower interval and the SoC interval may be defined as an upper/middle/lower interval to maintain each mapping table, but this is an example, and may be classified into more or less intervals according to the design of those skilled in the art. For example, when the load output magnitude interval is the upper interval and the SoC interval is the lower interval, the controller 70 may use only the stack. When both the load output magnitude interval and the SoC interval are the upper interval, the controller 70 may use both the stack and battery. When the load output magnitude interval is the lower interval and the SoC interval is the upper interval, the controller 70 may use only the battery.

The voltage upper/lower limit restriction strategy S753 may change to fix the voltage upper limit restriction value to a certain upper limit value c V and select and adjust the voltage lower limit restriction value in a certain lower limit range of a cell voltage, for example, between d V and e V depending on a condition (e.g., lowering d V during high-load mountain climbs and raising e V during efficiency-focused city driving).

Herein, c V may be included in the range of 0.8 V to 0.9 V and may be, for example, but is not limited to, 0.85 V. The certain lower limit range of the cell voltage may include a lower limit restriction value maximally applicable on the fuel cell system. d V in the certain lower limit range of the cell voltage may vary in the range of a value capable of being applied according to the situation of the fuel cell system. As an example, d V may be included in the range of 0.5 V to 0.7 V. Furthermore, e V in the certain lower limit range of the cell voltage may vary for each stack to stably provide an output in terms of durability of the stack. A value higher than d V applied on the fuel cell system may be applied. As an example, e V may be included in the range of 0.7 V to 0.8 V (e.g., e V set to 0.75 V for a new stack and 0.72 V for an aging stack to prolong service life).

When the vehicle enters the destination adjacent section as a result of the determination in S730, in S760, the controller 70 may release the strategy changed in response to the driving section and may change the strategy to the existing strategy. In other words, control may be performed to distribute the output to be suitable for a driver's intention via restoration to an existing control method and accurately comply with default SoC regulation (e.g., ensuring enough battery charge for low-speed maneuvering, parking, and accessory operation near the destination).

As an example, when energy necessary to charge SOC 1% of a specific hydrogen fuel vehicle is about 95.04 kJ, according to the example of FIG. 7, control should be performed such that a minimum SoC maintains 30% (hereinafter referred to as an “adjustment SoC target value”) immediately before the vehicle enters the destination adjacent section from the destination driving section and the SoC maintains an existing SoC target value, 60% (hereinafter referred to as a “default SoC target value”) before the vehicle arrives at a final destination after entering the destination adjacent section. Thus, as shown in an equation below, maximum energy for SOC regulation in the destination adjacent section may be energy necessary to perform charging from the adjustment SoC target value, 30%, and the default SoC target value, 60%. For example, this means an extra 2.85 MJ of energy may be allocated for final approach charging if the trip ends with a steep uphill climb to a parking area.

Maximum energy for charging=95.04 (kJ)×(60(%)−30(%))=2852 kJ

The controller 70 may pre-map a stack output command for meeting the default SoC target value after the vehicle enters the destination adjacent section. For example, if the stack output command is mapped to 10 kW (CAL), the controller may plan to sustain that output level until the target SoC is reached. A maximum time required to meet the default SoC target value may be calculated as an equation below.

Maximum time required (Max_required_min)=(2852 (kJ)/10 (kJ/s))/60 (s)=4.75 minutes (e.g., roughly five minutes of steady 10 kW output would raise SoC from 30% to 60% under ideal conditions.

When the stack output command for the default SoC target value is the form of MAP, the maximum time required to meet the default SoC target value may be calculated by using an average value of MAP as a representative value. For example, if an average stack output command on the stack output command MAP is 15 kW(CAL), the maximum time required may be calculated as an equation below.

Maximum time required (Max_required_min)=(2852 (kJ)/15 (kJ/s))/60 (s)=3.17 minutes (allowing faster SoC recovery before arrival.)

At this time, a point at which the accumulated sum of an estimated time taken for each road section (counted in reverse from the destination) equals a minimum time required may be determined as a starting point of the destination adjacent section and a distance from the starting point of the destination adjacent section to the destination may be calculated (e.g., 4 km from the destination if average approach speed is 50 km/h and 5 minutes are required for SoC recovery).

Because the controller 70 is able to know a distance and an estimated speed for each road section based on navigation information, it may determine the starting point of the destination adjacent section corresponding to the maximum time required to meet the default SoC target value with sufficient buffer to account for speed fluctuations.

The controller 70 according to an example may collect real-time traffic situation information to update the starting point of the destination adjacent section while the vehicle is driving in the destination driving section and may determine the current starting point of the destination adjacent section as a final value, when the vehicle enters within a certain distance, for example, 100 m from the most recently updated starting point of the destination adjacent section (e.g., adjusting the entry point closer if unexpected congestion shortens available charging time).

The controller 70 according to another example may update the starting point of the destination adjacent section at a certain period based on the real-time traffic situation information and the current SoC while the vehicle is driving in the destination driving section and may determine the current starting point of the destination adjacent section as a final value, when the vehicle enters within the certain distance, for example, 100 m from the most recently updated starting point of the destination adjacent section (e.g., recalculating every two minutes in heavy traffic).

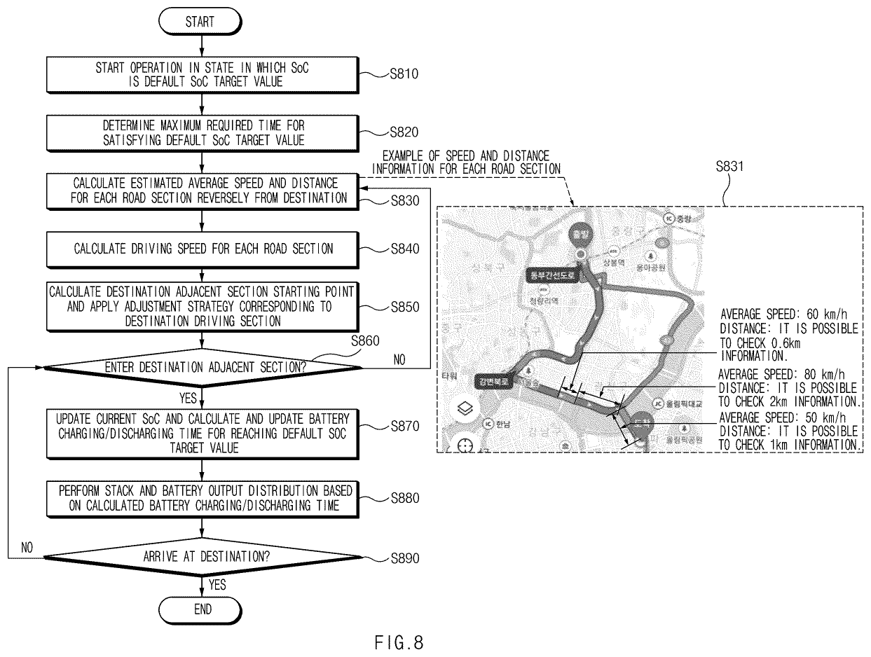

FIG. 8 shows an example of a method for controlling a stack and battery output to improve durability in a fuel cell vehicle according to another example of the present disclosure.

In detail, the method of FIG. 8 may be performed by the vehicle fuel cell system 200 of FIG. 2, which is described above. The vehicle fuel cell system 200 may interwork with audio video navigation (AVN) over an in-vehicle network to obtain information about a driving route to a destination and a traffic situation for each road section, may adaptively divide and update the driving section to the destination into a destination driving section and a destination adjacent section, and may adaptively adjust SoC regulation for each divided section to perform stack and battery output distribution (e.g., more aggressive battery discharge in early route segments, then fuel cell recharge near arrival).

Referring to FIG. 8, in S810, the vehicle fuel cell system 200 may start an operation of a vehicle in a state in which an SoC is a default SoC target value after the driving route to the destination is set.

After the vehicle arrives at the destination, in S820, the vehicle fuel cell system 200 may determine a maximum time required to meet the default SoC target value. Herein, the method for calculating the maximum time required may be replaced with the description of FIG. 7.

As shown in reference numeral 831, in S830 and S840, the vehicle fuel cell system 200 may calculate an estimated average speed and distance for each road section reversely from the destination and may calculate a driving speed for each road section based on the calculated average speed and distance for each road section (e.g., a 1 km city section at 20 km/h=3 minutes).

In S850, the vehicle fuel cell system 200 may calculate a point at which the value obtained by accumulating and adding the driving time for each road section, which is calculated from the destination, is identical to the maximum time required as a destination adjacent section starting point. Herein, the vehicle fuel cell system 200 may divide the driving route into the destination driving section and the destination adjacent section based on the calculated destination adjacent section starting point and may set default SoC regulation and a default strategy to SoC regulation and an adjustment strategy corresponding to the destination driving section.

In S860, the vehicle fuel cell system 200 may determine whether the vehicle enters the destination adjacent section.

When the vehicle enters the destination adjacent section as a result of the determination, in S870, the vehicle fuel cell system 200 may switch SoC regulation corresponding to the destination driving section (hereinafter referred to as an “adjustment SoC regulation”) and an adjustment strategy to default SoC regulation and a default strategy, may update a current SoC, and may calculate and update a battery charging/discharging time for reaching a default SoC target value based on the updated SoC (e.g., reducing charging demand if SoC is already at 55%).

In S880, the vehicle fuel cell system 200 may perform stack and battery output distribution based on the calculated battery charging/discharging time (e.g., prioritizing fuel cell output if arrival SoC is significantly below target).

In S890, the vehicle fuel cell system 200 may determine whether the vehicle arrives at the destination and may end output control, when the vehicle arrives at the destination.

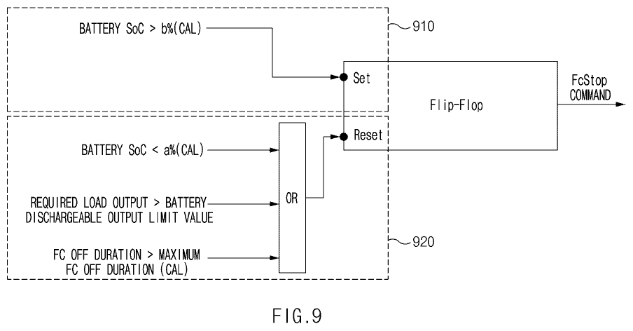

FIG. 9 shows an example of control logic according to an FC ON/OFF control strategy in a destination driving section according to an example of the present disclosure.

Referring to reference numeral 920, when at least one of three conditions below is met, Reset of a flip-flop may be activated. In this case, an FcStop command for FC ON, that is, 0 may be output from the flip-flop. When switching to an FC ON state depending on the FcStop command, the state may be maintained until an FC OFF condition is met.
1) Battery SoC<a % (CAL). For example, a % may be 30% but may vary with specifications and a use environment of the fuel cell system.
2) Required load output>battery dischargeable output limit
3) FC OFF duration>maximum FC OFF duration (CAL)

Herein, the required load output may be calculated as the sum of a required driver driving output, vehicle accessories output consumption, and fuel cell accessories output consumption (e.g., coolant pump, compressor).

When the required load output is greater than a battery dischargeable output limit while driving using only the battery output in an FC OFF state, the controller 70 should switch from the FC OFF state to the FC ON state to prevent power shortfall.

Furthermore, maintenance of the FC OFF state for a long time together with frequent FC ON/OFF switching may negatively affect stack durability. Thus, when the FC OFF duration reaches a maximum FC OFF duration, the FC OFF state should switch to the FC ON state to refresh stack operation and maintain health.

Referring to reference numeral 910, when the condition in which the battery SoC is greater than b % (CAL) is met, Set of a flip-flop may be activated. In this case, an FcStop command for FC OFF, that is, 1 may be output from the flip-flop. When switching to an FC OFF state depending on the FcStop command, the state may be maintained until the above-mentioned FC ON condition is met. For example, b % may be 80% and may vary with specifications and a use environment of the fuel cell system.

In FIG. 9, b may be set to be greater than a (e.g., a=30%, b=80%) to create a hysteresis band that prevents rapid toggling between ON and OFF states example.

An FC ON/OFF control method according to the above-mentioned existing logic of FIG. 5 considers both a magnitude of a required fuel cell output and an amount of accelerator pedal manipulation. However, in the present disclosure, the magnitude of the required fuel cell output and the amount of accelerator pedal manipulation are excluded to allow more flexible use of the battery. However, because the magnitude of the required fuel cell output and the amount of accelerator pedal manipulation should be considered to comply with a default SoC target value, the vehicle may be controlled to transition back to existing logic and respond more sensitively to drive output demands, if it enters a destination adjacent section.

Hereinafter, a description will be given of control logic according to an output distribution control strategy in the destination driving section according to an example of the present disclosure.

As described above in FIG. 9, the required load output P_{load} may be determined as the sum of a required driver driving output, vehicle accessories output consumption, and fuel cell accessories output consumption.

When representing an output generated when a cell voltage is x V as P_{@xV}, an output distribution strategy may be differently defined according to the result of comparing the required load output P_{load} with P_{@xV} as follows.

As an example, when P_{load}≤P_{@xV}, the controller 70 may respond using a stack-only output strategy. The target stack output at this time may be determined based on P_{load} and the currently set target SoC regulation value. It is unable to have an influence on durability, even when the stack corresponds to the entire P_{load} in an area where P_{load}≤P_{@xV} and it is able to reduce a battery output and manage a battery temperature as much as the battery is not used. For example, because P_{load} is within the stack's capability in this region, durability impact is minimal, and the battery may be rested —reducing battery temperature rise.

As an example, when P_{load}>P_{@xV}, the controller 70 may respond using a stack and battery output distribution strategy. The target stack output at this time may be determined based on a basically determined output distribution ratio. However, when the current SoC enters less than a minimum SoC regulation value (e.g., 40%) in the destination driving section, the controller 70 may adjust an output distribution ratio of the stack so that the stack's contribution ratio, 1 or more, maintaining an SoC regulation range defined in response to the destination driving section (or the set target SoC regulation value). For example, if SoC is low and P_{load} exceeds stack capacity, the battery may still assist but with minimized draw to prevent further SoC drop. An output distribution ratio for each output area may be pre-mapped and defined, as in existing logic, in a region where P_{load}>P_{@xV} so output may be tailored to the situation.

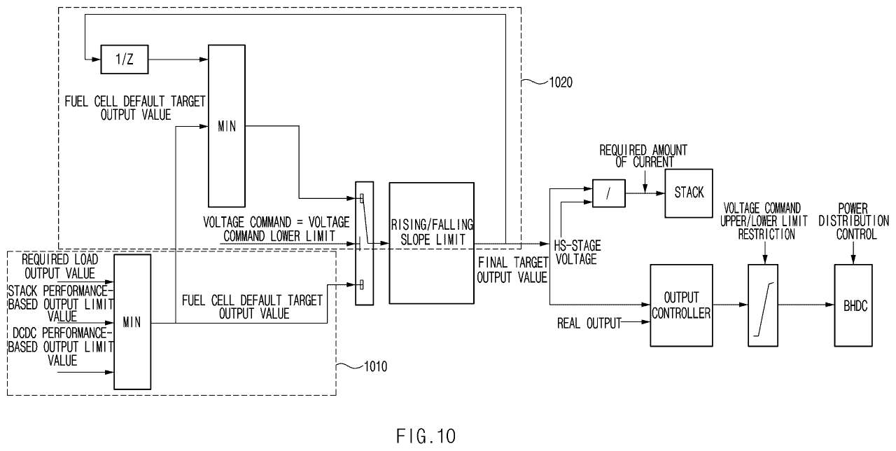

FIG. 10 shows an example of control logic according to a voltage upper/lower limit control strategy in a destination driving section according to an example of the present disclosure.

In detail, FIG. 10 shows an example of logic for determining a target output (e.g., target power request from the fuel cell stack, power split ratio, or load allocation setting, etc.).

A fuel cell default target output value according to the present disclosure may be defined as a value obtained by limiting a required load output based on stack and DCDC performance (e.g., maximum sustainable stack power, converter efficiency constraints, or thermal protection limits, etc.). In other words, as shown in reference numeral 1010, the fuel cell default target output value may be determined as a minimum value among the required load output, a stack performance-based output limit value, and a DCDC performance-based output limit value.

A target fuel cell output is determined as a final required output rather than a required load output in the existing logic of FIG. 4. On the other hand, as shown in reference numeral 1020, control logic according to an example may determine the final target output as a minimum value between a final target output in a previous step and the fuel cell default target output value, when the voltage command is limited to a voltage lower limit value (e.g., 0.7 V for efficiency preservation or 0.65 V for temporary high-load support, etc.).

Because it is not possible to decrease a voltage any longer although the final target output increases from a time point when the voltage command is identical to the voltage lower limit value, an increase in the final target output should be limited (e.g., to avoid excessive current draw, prevent rapid SoC depletion, or reduce stack degradation, etc.).

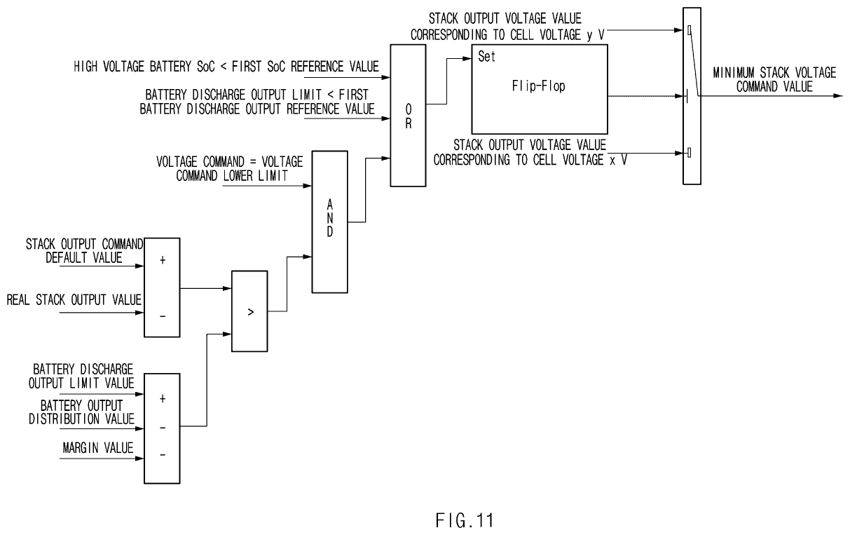

FIG. 11 shows an example of voltage command upper/lower limit control logic in a destination driving section according to an example of the present disclosure (e.g., approaching a charging station, reaching a depot, or preparing for an urban low-emission zone, etc.).

In detail, FIG. 11 shows an example of control logic for changing a cell voltage from x V to y V depending on a voltage command lower limit restriction strategy in a destination driving section (e.g., lowering cell voltage for power boost or raising it for efficiency, etc.).

A voltage lower limit value may be basically limited to a voltage corresponding to x V and may be included in, for example, 0.7 V to 0.8 V (e.g., 0.72 V, 0.75 V, or 0.78 V for different stack designs, etc.).

When a voltage upper/lower limit control strategy according to an example of the present disclosure meets any one of the following three conditions, the voltage lower limit value may be defined to change to the voltage corresponding to the cell voltage y V and release existing voltage command lower limit restriction. As an example, y V may be included in the range of 0.5 V to 0.7 V (e.g., 0.55 V for short-duration boost, 0.65 V for sustained climb, etc.).
1. When the SoC is lower than a first SoC reference value (e.g., 35%, 30%, or 25%, etc.)
2. When the battery discharge output limit value is lower than a first battery discharge output reference value (e.g., 40 kW, or a limit reduced due to low temperature, etc.)
3. When the following condition is met, while the voltage command is limited to the voltage lower limit value (default target output value−real fuel cell output)>(battery discharge output limit value−battery output distribution value−margin value)

The first condition is to prevent SoC over-discharging, when the SoC is lower than the first SoC reference value (e.g., ensuring minimum charge to reach destination, protecting battery life, or maintaining reserve for sudden acceleration, etc.).

The second condition is to deactivate logic when the battery discharge output limit value is lower a certain reference value depending on a battery temperature or abnormality in state, other than the SoC (e.g., during cold starts, overheating events, or detected cell imbalance, etc.) when the battery discharge output limit value is lower than the first battery discharge output reference value.

In the third condition, the real fuel cell output value has an output lower than the default target output value, when the voltage command is limited to the voltage lower limit value in the situation in which the default target output value increases. In other words, there may occur a situation in which the voltage command should further decrease, but is limited to the voltage lower limit value to output the default target output value. At this time, when there is a situation in which the battery is able to assist with an output by a difference between the default target output value and the real fuel cell output value, it is fine that the output limited by the voltage lower limit value is maintained (e.g., battery covers sudden torque demand during acceleration, hill climbing, or overtaking, etc.). However, when the condition is not met, for example, when there is the situation in which the battery is unable to assist with the output by the difference between the default target output value and the real fuel cell output value, the voltage lower limit restriction should be released. Herein, when the value obtained by subtracting the battery output distribution value from the battery discharge limit value is greater than 0 or is greater than or equal to a certain reference value, it may be determined that it is possible to assist with the output of the battery. When the voltage command lower limit restriction is not released even when the above condition is met, it is impossible to ensure drivability suitable for a driver's intention due to a lack of output (e.g., sluggish acceleration, inability to maintain highway speed, or failure to merge safely, etc.). In other words, the problem of deterioration in vehicle drivability may be caused.

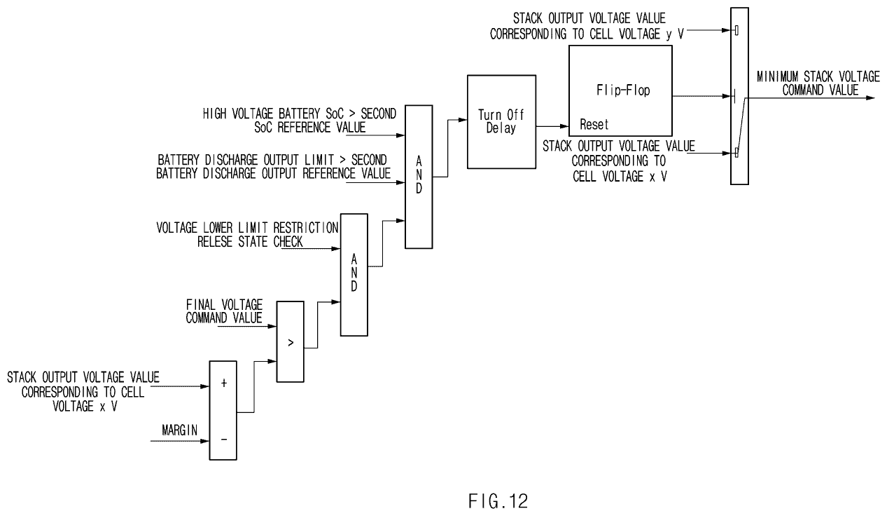

FIG. 12 shows an example of voltage command upper/lower limit control logic in a destination driving section according to another example of the present disclosure (e.g., downhill recovery mode, city entry mode, or battery preconditioning phase, etc.).

In detail, FIG. 12 shows an example of change release control logic for limiting the cell voltage y V changed as described in FIG. 11 to an existing cell voltage x V again depending on a voltage command lower limit restriction strategy. As an example, x V may be included in the range of 0.7 V to 0.8 V and y V may be included in the range of 0.5 V to 0.7V (e.g., 0.68 V when partially restoring efficiency while keeping some boost capability, etc.).

The voltage upper/lower limit control strategy according to an example of the present disclosure may be defined to switch a voltage lower limit value to a voltage value corresponding to the cell voltage x V, when all three conditions below are met, and change and release the previously changed voltage lower limit value, that is, the voltage corresponding to the cell voltage y V.
1. When the SoC is higher than a second SoC reference value (e.g., 45%, 50%, or 55%, etc.)
2. When the battery discharge output limit value is higher than a second battery discharge output reference value (e.g., 60 kW after warming up, or restored after fault clearance, etc.)
3. When the final voltage command value is greater than a value obtained by subtracting a certain margin from a stack output voltage corresponding to the cell voltage x V (e.g., 0.75 V minus 0.02 V margin, etc.)

The case in which the voltage lower limit value changes to the cell voltage y V is a driving situation in which the required load output is high as much as the stack output is required (e.g., climbing a steep grade, towing a trailer, or high-speed acceleration, etc.). At this time, it is checked that the voltage command increases to the cell voltage x V or more as the stack output is sufficiently lowered and the voltage lower limit should be limited again to ensure control stability (e.g., avoiding over-voltage conditions or sudden efficiency drop, etc.). When it is limited again without meeting the condition, deterioration in vehicle drivability may occur due to a sudden increase in voltage (e.g., abrupt torque reduction or noticeable driveline jerk, etc.).

The voltage upper/lower limit control strategy according to an example of the present disclosure may be defined to determine a voltage command upper limit value as a stack output voltage corresponding to a cell voltage, for example, a cell voltage included in 0.8 V to 0.9V in the destination driving section (e.g., 0.82 V for efficiency, 0.88 V for performance reserve, etc.). When the vehicle enters a destination adjacent section, a voltage command upper limit value may be determined based on a high voltage battery SoC (e.g., limit lowered if SoC>90%, etc.).

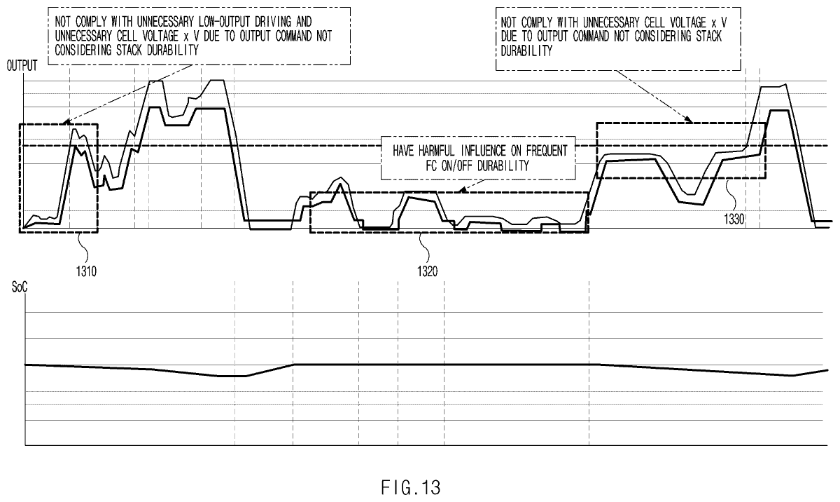

FIG. 13 shows an exemplary output profile for describing a problem which occurs when applying an output distribution strategy (e.g., inefficient energy use, excessive FC cycling, or unnecessary battery drain, etc.).

An interval in reference numeral 1310 shows a state in which unnecessary low output driving and an unnecessary cell voltage x V generated due to an output command not considering stack durability are not complied. As an example, x V may be included in the range of 0.7 V to 0.8 V (e.g., 0.75 V during low-speed cruise without load, etc.).

An interval in reference numeral 1320 shows a state in which it has a harmful influence on stack durability depending on frequent FC ON/OFF control (e.g., cycling more than 10 times in a short trip, etc.).

An interval in reference numeral 1330 shows a state in which an unnecessary cell voltage x V generated due to an output command not considering stack durability is not complied (e.g., steady-state at 0.78 V without power demand, etc.).

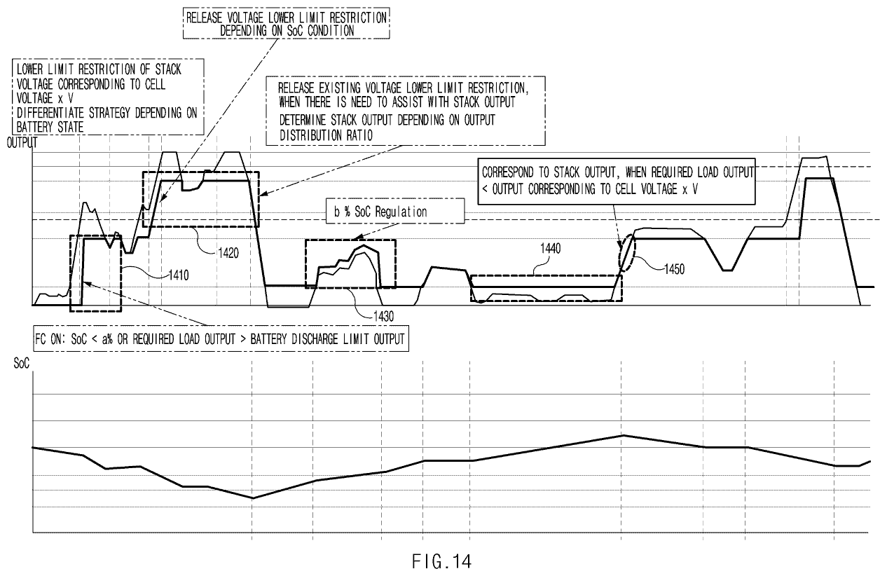

FIG. 14 shows an exemplary output profile when applying an output distribution and FC ON/OFF strategy according to the present disclosure (e.g., combining battery and FC operation to minimize cycling and improve efficiency, etc.).

An interval in reference numeral 1410 shows an output is limited to suit FC ON and a cell voltage x V, as it is impossible to correspond to the battery because the battery has 80 kW (e.g., insufficient battery discharge headroom for high torque, etc.). As an example, x V may be included in the range of 0.7 V to 0.8 V.

An interval in reference numeral 1420 shows that the output increases as voltage lower limit restriction is released by another condition except for not reaching an SoC reference value (e.g., temporary boost for overtaking, etc.).

An interval in reference numeral 1430 shows that the stack output is controlled to be greater than a required load output to comply with SoC regulation b % (e.g., charging battery during light load driving, etc.). As an example, b % may be, but is not limited to 40%.

An interval in reference numeral 1440 shows FC ON is maintained and controlled continuously until the SoC is c % (e.g., 75%, 80%, or 85%, etc.). As an example, c % may be, but is not limited to, 80%. In FIG. 14, a, b, and c may be as a<b<c.

An interval in reference numeral 1450 shows corresponding to the stack output, when the required load output is less than an output corresponding to the cell voltage x V (e.g., downhill cruising or light-load urban driving, etc.). As an example, x V may be included in the range of 0.7 V to 0.8 V.

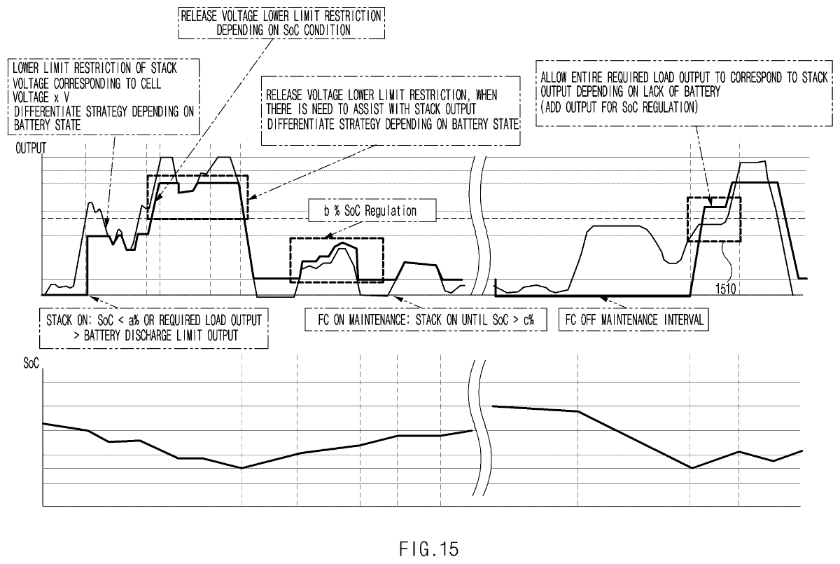

FIG. 15 shows an exemplary output profile when applying an output distribution and FC ON/OFF strategy according to the present disclosure (e.g., managing charge before long uphill section or before arrival at depot, etc.).

In detail, FIG. 15 shows an example of a stack and battery operation strategy when there is a need to charge the battery upon FC ON (e.g., to ensure sufficient SoC before entering EV-only zone, etc.).

Referring to FIG. 15, an FC ON state is maintained until an SoC reaches c %. When the SoC reaches c %, the FC ON state switches to an FC OFF state. The FC OFF state is maintained, until the SoC is a %. When the SoC reaches a % in the FC OFF state, as the FC is ON, the stack output may be used for charging covering the entire required load output and simultaneously meeting a target SoC regulation value (e.g., adding 10 kW for battery charging while providing 50 kW for load, etc.). As shown in reference numeral 1510, in the stack output, an output necessary to meet a target SoC regulation value may be added to an output for covering the entire required load power. As an example, c % may be, but is not limited to, 80% and a % may be, but is not limited to, 30%.

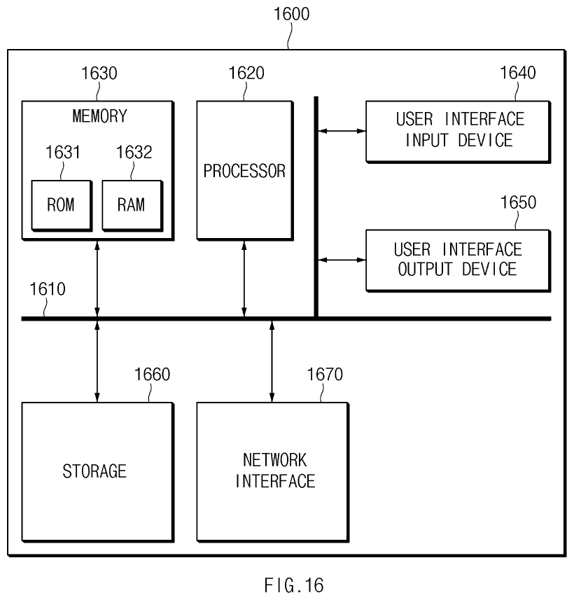

FIG. 16 shows an example computing system according to an example of the present disclosure.

Referring to FIG. 16, a computing system 1600 may include at least one processor 1620, a memory 1630, a user interface input device 1640, a user interface output device 1650, a storage 1660, and a network interface 1670, which are connected with each other via a bus 1610 (e.g., a high-speed serial bus, a parallel bus, or a Controller Area Network (CAN) bus, etc.).

The processor 1620 may be a central processing unit (CPU) or a semiconductor device that processes instructions stored in the memory 1630 and/or the storage 1660 (e.g., a microcontroller, a system-on-chip (SoC), or a digital signal processor (DSP), etc.). The memory 1630 and the storage 1660 may include various types of volatile or non-volatile storage media (e.g., DRAM, SRAM, NAND flash, magnetic storage, or optical storage, etc.). For example, the memory 1630 may include a ROM (Read Only Memory) 1631 and a RAM (Random Access Memory) 1632 (e.g., DDR4 SDRAM, LPDDR5, or embedded SRAM, etc.).

Accordingly, the operations of the method (or procedure) or algorithm described in connection with the examples disclosed in the specification may be directly implemented with a hardware module, a software module, or a combination of the hardware module and the software module, which is executed by the processor 1620 (e.g., FPGA logic blocks, embedded firmware routines, or hybrid control systems, etc. The software module may reside on a storage medium (i.e., the memory 1630 and/or the storage module 1060) such as a RAM, a flash memory, a ROM, an EPROM, an EEPROM, a register, a hard disc, a removable disk, and a CD-ROM (e.g., SD card, USB flash drive, or Blu-ray disc, etc.). As an example, the processor 1620 may constitute a part of the above-mentioned fuel cell vehicle system and may correspond to the controller (ECU) 70 of FIG. 2 (e.g., managing power distribution, cooling control, or hydrogen flow regulation, etc.).

The exemplary storage medium may be coupled to the processor 1620 (e.g., via PCIe, SATA, or NVMe interface, etc.). The processor 1620 may read out information from the storage medium and may write information in the storage medium. Alternatively, the storage medium may be integrated with the processor 1620 (e.g., in a stacked package or a monolithic SoC, etc.). The processor and the storage medium may reside in an application specific integrated circuit (ASIC) (e.g., a vehicle control ASIC optimized for real-time signal processing, etc.). The ASIC may reside in the control unit in the vehicle. Alternatively, the processor 1620 and storage medium may reside as separate components in the vehicle control unit (e.g., mounted on the same PCB but in distinct IC packages, etc.).

An example of the present disclosure provides a method for controlling a stack and battery output to improve durability of a fuel cell stack and an apparatus therefor.

Another example of the present disclosure provides a method for controlling a fuel cell system to adaptively distribute a stack and battery output depending on a driving area and a driving environment of a vehicle to ensure stack durability and improve fuel efficiency and an apparatus therefor.

Another example of the present disclosure provides a method for controlling a fuel cell system to classify an operation area based on destination setting information of navigation and adaptively apply a durability acquisition strategy and an SoC stability acquisition strategy depending on the classified area to ensure stack durability and provide battery stability for next driving and an apparatus therefor.

Another example of the present disclosure provides a method for controlling a fuel cell system to adaptively distribute a fuel cell and battery output based on a real-time driving environment to a destination to ensure stack durability and improve fuel efficiency and an apparatus therefor.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a method for distributing an output in a vehicle fuel cell system including a fuel cell (FC) stack and a high voltage battery may include collecting information about a driving route to a destination and traffic congestion information for each road section corresponding to the driving route, dividing the driving route into a first section and a second section based on the traffic congestion information for each road section, and applying different output distribution strategies to the first section and the second section.

As an example, the second section may be a destination adjacent section and ON/OFF of the stack may be controlled according to a default output distribution strategy to comply with predefined default state of charge (SoC) regulation in the second section.

As an example, the first section may be a destination driving section and a charging/discharging range of the battery may be applied to be greater than the default output distribution strategy in the first section compared to the second section to minimize an ON/OFF switching frequency of the stack.

As an example, a target SoC regulation value corresponding to the first section may be set to a value less than a default SoC regulation value.

As an example, the second section may be determined such that the default SOC regulation is satisfied when a vehicle arrives at the destination. A starting point of the second section may be determined as a point at which the sum of an estimated time taken for each road section, the estimated time taken being calculated reversely from the destination, is identical to a time required to reach the default SoC regulation after the vehicle enter the second section.

As an example, the information about the driving route to the destination and the traffic congestion information for each road section corresponding to the driving route may be collected over an in-vehicle communication network from navigation provided in a corresponding vehicle.

As an example, the output distribution strategy corresponding to the first section may include an FC ON/OFF strategy defining ON/OFF switching logic of an FC, an output distribution strategy defining output distribution strategy of the stack and the battery according to a required load output and an SoC state, and a voltage upper/lower limit restriction strategy defining voltage upper/lower limit restriction logic of the stack.

As an example, the FC ON/OFF switching logic may include logic for generating a first fuel cell stop (FcStop) command for switching to an FC ON state, if an SoC of the battery is less than a first reference value in an FC OFF state, the required load output is greater than a certain battery dischargeable output limit value, a duration of the FC OFF state is greater than a certain maximum FC OFF duration and logic for generating a second FcStop command for switching to the FC OFF state based on that the SoC of the battery is greater than a second reference value in the FC ON state.

As an example, the voltage upper/lower limit restriction logic of the stack may include logic for fixing a voltage upper limit restriction value of the stack to a stack voltage corresponding to a first cell voltage and logic for changing a stack voltage corresponding to a default cell voltage to a stack voltage corresponding to a second cell voltage, if a certain voltage lower limit change condition is met. The second cell voltage may be less than the default cell voltage and the first cell voltage may be greater than the default cell voltage.

As an example, the voltage lower limit change condition may be met based on that meeting any one of a first condition in which the SoC of the battery is less than certain first SoC criteria, a second condition in which a discharge output limit value of the battery is less than a first battery discharge output reference value, and a third condition in which (default target output value−real FC output)>(battery discharge output limit value−battery output distribution value−margin value) as a voltage command is limited to a voltage lower limit value.

According to another example of the present disclosure, a computing device provided in a vehicle fuel cell system including a fuel cell (FC) stack and a high voltage battery may include a processor that executes instructions and a memory storing the instructions. The processor may collect information about a driving route to a destination and traffic congestion information for each road section corresponding to the driving route, divide the driving route into a first section and a second section based on the traffic congestion information for each road section, and apply different output distribution strategies to the first section and the second section.

As an example, the second section may be a destination adjacent section. The processor may control ON/OFF of the stack depending on a predefined default output distribution strategy to comply with predefined default state of charge (SoC) regulation in the second section.

As an example, the first section may be a destination driving section. The processor may apply a charging/discharging range of the battery to be greater than the default output distribution strategy in the first section compared to the second section to minimize an ON/OFF switching frequency of the stack.

As an example, the processor may set a target SoC regulation value corresponding to the first section to a value less than a default SoC regulation value.

As an example, the processor may determine the second section such that the default SOC regulation is met if a vehicle arrives at the destination. A starting point of the second section may be determined as a point at which the sum of an estimated time taken for each road section, the estimated time taken being calculated reversely from the destination, is identical to a time required to reach the default SoC regulation after the vehicle enter the second section.

As an example, the processor may collect the information about the driving route to the destination and the traffic congestion information for each road section corresponding to the driving route over an in-vehicle communication network from navigation provided in a corresponding vehicle.

As an example, the output distribution strategy corresponding to the first section may include an FC ON/OFF strategy defining ON/OFF switching logic of an FC, an output distribution strategy defining output distribution strategy of the stack and the battery according to a required load output and an SoC state, and a voltage upper/lower limit restriction strategy defining voltage upper/lower limit restriction logic of the stack.

As an example, the FC ON/OFF switching logic may include logic for generating a first fuel cell stop (FcStop) command for switching to an FC ON state, if an SoC of the battery is less than a first reference value in an FC OFF state, the required load output is greater than a certain battery dischargeable output limit value, a duration of the FC OFF state is greater than a certain maximum FC OFF duration and logic for generating a second FcStop command for switching to the FC OFF state based on that the SoC of the battery is greater than a second reference value in the FC ON state.

As an example, the voltage upper/lower limit restriction logic of the stack may include logic for fixing a voltage upper limit restriction value of the stack to a stack voltage corresponding to a first cell voltage and logic for changing a stack voltage corresponding to a default cell voltage to a stack voltage corresponding to a second cell voltage, if a certain voltage lower limit change condition is met. The second cell voltage may be less than the default cell voltage and the first cell voltage may be greater than the default cell voltage.

As an example, the voltage lower limit change condition may be met based on that meeting any one of a first condition in which the SoC of the battery is less than certain first SoC criteria, a second condition in which a discharge output limit value of the battery is less than a first battery discharge output reference value, and a third condition in which (default target output value−real FC output)>(battery discharge output limit value−battery output distribution value−margin value) as a voltage command is limited to a voltage lower limit value.

The present technology may provide the method for controlling the stack and battery output to improve the durability of the fuel cell stack (e.g., by reducing high-load transients, avoiding unnecessary start-stop cycles, or optimizing thermal management, etc.) and the apparatus therefor.

Furthermore, the present technology may provide the method for controlling the fuel cell system to adaptively distribute a stack and battery output depending on a driving area and a driving environment of a vehicle (e.g., highway driving, urban stop-and-go traffic, mountainous terrain, or extreme temperature conditions, etc.) to ensure stack durability and improve fuel efficiency and the apparatus therefor.

Furthermore, the present technology may provide the method for controlling the fuel cell system to classify an operation area based on destination setting information of a navigation system (e.g., long-distance highway travel, short city trips, uphill climbing routes, or coastal roads, etc.) and adaptively apply a durability acquisition strategy and an SoC stability acquisition strategy depending on the classified area (e.g., limiting stack output in high-degradation zones or prioritizing battery charging before steep inclines, etc.) to ensure stack durability performance and provide battery stability for next driving and the apparatus therefor.

Furthermore, the present technology may provide the method for controlling the fuel cell system to adaptively distribute a fuel cell and battery output based on a real-time driving environment to a destination to ensure stack durability performance and improve fuel efficiency and the apparatus therefor.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Accordingly, examples of the present disclosure are intended not to limit but to explain the technical idea of the present disclosure, and the scope and spirit of the invention is not limited by the above examples. The scope of the present disclosure should be construed on the basis of the accompanying claims, and all the technical ideas within the scope equivalent to the claims should be included in the scope of the present disclosure.

What is claimed is:

1. A method performed by an apparatus of a vehicle, the method comprising:
obtaining information about:
a driving route of the vehicle to a destination, and
traffic congestion information for each of a plurality of road segments, wherein the plurality of road segments are associated with the driving route;
dividing, based on the traffic congestion information, the plurality of road segments into a first section and a second section;
generating a signal indicating a first output distribution strategy for the first section and a second output distribution strategy for the second section; and
controlling, based on the signal, operation of a fuel cell stack of the vehicle and operation of a battery of the vehicle.

2. The method of claim 1, further comprising:
for the vehicle driving in the second section that is a destination adjacent section, controlling ON/OFF of the fuel cell stack based on the second output distribution strategy such that a predefined default state of charge (SoC) regulation of the battery is satisfied.

3. The method of claim 2, further comprising:
for the vehicle driving in the first section that is a destination driving section, adjusting a charging/discharging range of the battery to be greater than a charging/discharging range of the battery for driving the vehicle in the second section such that an ON/OFF switching frequency of the fuel cell stack for the driving in the first section is less than an ON/OFF switching frequency of the fuel cell stack for the driving in the second section.

4. The method of claim 3, further comprising:
based on the vehicle driving in the first section, setting a target SoC regulation value of the battery to a value less than a default SoC regulation value of the battery that is set for the vehicle driving in the second section.

5. The method of claim 2, wherein the second section is determined such that the predefined default SOC regulation is satisfied when the vehicle arrives at the destination, and
wherein a starting point of the second section is determined as a point at which a sum of an estimated time taken for each of the plurality of road segments in the second section equals a time required to reach the predefined default SoC regulation after the vehicle enters the second section, wherein the estimated time taken for each of the plurality of road segments in the second section is calculated reversely from the destination.

6. The method of claim 1, wherein the information about the driving route to the destination and the traffic congestion information are obtained from a navigation system of the vehicle via an in-vehicle communication network.

7. The method of claim 1, wherein the first output distribution strategy comprises:
a fuel cell (FC) ON/OFF strategy defining ON/OFF switching logic of the fuel cell stack;
a power output distribution strategy of the fuel cell stack and the battery based on a required load output of the vehicle and an SoC state of the battery; and
a voltage upper/lower limit restriction strategy defining voltage upper/lower limit restriction logic of the fuel cell stack.

8. The method of claim 7, wherein the ON/OFF switching logic comprises:
a first logic for generating a first fuel cell stop (FcStop) command for switching to an FC ON state, based on:
an SoC of the battery being less than a first reference value in an FC OFF state,
the required load output being greater than a battery dischargeable output limit value, and
a duration of the FC OFF state being greater than a threshold FC OFF duration; and
a second logic for generating a second FcStop command for switching to the FC OFF state based on the SoC of the battery being greater than a second reference value in the FC ON state.

9. The method of claim 8, wherein the voltage upper/lower limit restriction logic comprises:
a first logic for adjusting a voltage upper limit restriction value of the fuel cell stack to a stack voltage corresponding to a first cell voltage; and
a second logic for changing a stack voltage corresponding to a default cell voltage to a stack voltage corresponding to a second cell voltage, based on a voltage lower limit change condition being satisfied,
wherein the second cell voltage is less than the default cell voltage, and
wherein the first cell voltage is greater than the default cell voltage.

10. The method of claim 9, wherein the voltage lower limit change condition is satisfied based on at least one of:
a first condition in which the SoC of the battery is less than first SoC criteria;
a second condition in which a discharge output limit value of the battery is less than a first battery discharge output reference value; or
a third condition in which a first value is greater than a second value, wherein the first value is a difference between a default target output value and a real FC output, wherein the second value is obtained by subtracting a battery output distribution value and a margin value from a battery discharge output limit value, and wherein a voltage command is limited to a voltage lower limit value.

11. An apparatus of a vehicle, the apparatus comprising:
a processor; and
a memory storing at least one instruction that, when executed by the processor communicating with the memory, is configured to cause the apparatus to:
obtain information about:
a driving route of the vehicle to a destination, and
traffic congestion information for each of a plurality of road segments, wherein the plurality of road segments are associated with the driving route,
divide, based on the traffic congestion information, the plurality of road segments into a first section and a second section,
generate a signal indicating a first output distribution strategy for the first section and a second output distribution strategy for the second section, and
control, based on the signal, operation of a fuel cell stack of the vehicle and operation of a battery of the vehicle.

12. The apparatus of claim 11, wherein the at least one instruction, when executed by the processor communicating with the memory, is configured to cause the apparatus to, for the vehicle driving in the second section that is a destination adjacent section, control ON/OFF of the fuel cell stack based on the second output distribution strategy such that a predefined default state of charge (SoC) regulation of the battery is satisfied in the second section.

13. The apparatus of claim 12, wherein the at least one instruction, when executed by the processor communicating with the memory, is configured to cause the apparatus to, for the vehicle driving in the first section that is a destination driving section, adjust a charging/discharging range of the battery to be greater than a charging/discharging range of the battery for driving the vehicle in the second section such that an ON/OFF switching frequency of the fuel cell stack for the driving in the first section is less than an ON/OFF switching frequency of the fuel cell stack for the driving in the second section.

14. The apparatus of claim 13, wherein the at least one instruction, when executed by the processor communicating with the memory, is configured to cause the apparatus to:
based on the vehicle driving in the first section, set a target SoC regulation value of the battery to a value less than a default SoC regulation value of the battery that is set for the vehicle driving in the second section.

15. The apparatus of claim 12, wherein the at least one instruction, when executed by the processor communicating with the memory, is configured to cause the apparatus to:
determine the second section such that the predefined default SOC regulation is satisfied when the vehicle arrives at the destination, and
wherein a starting point of the second section is determined as a point at which a sum of an estimated time taken for each of the plurality of road segments in the second section equals a time required to reach the predefined default SoC regulation after the vehicle entering the second section.

16. The apparatus of claim 11, wherein the at least one instruction, when executed by the processor communicating with the memory, is configured to cause the apparatus to:
obtain, via an in-vehicle communication network from a navigation system of the vehicle, the information about the driving route to the destination and the traffic congestion information.

17. A vehicle comprising:
a battery;
a fuel cell stack;
a processor; and
a memory storing at least one instruction that, when executed by the processor communicating with the memory, is configured to cause the vehicle to:
obtain information about:
a driving route of the vehicle to a destination, and
traffic congestion information for each of a plurality of road segments, wherein the plurality of road segments are associated with the driving route,
based on the traffic congestion information, classify the plurality of road segments into a first section and a second section, wherein the first section and the second section are defined based on the destination,
apply, during the vehicle driving in the first section, a first output distribution configured to control ON/OFF of the fuel cell stack to reduce a switching frequency of the fuel cell stack and adjust a charging/discharging range of the battery, and
apply, during the vehicle driving in the second section, a second output distribution configured to control ON/OFF of the fuel cell stack such that a state of charge (SoC) of the battery satisfies a target SoC of the battery upon the vehicle arriving at the destination.

18. The vehicle of claim 17, wherein the at least one instruction, when executed by the processor communicating with the memory, is configured to cause the vehicle to, based on a degree of traffic congestion level in the first section, adjust the target SoC of the battery, wherein the target SoC is lowered based on the degree of traffic congestion level being high, and wherein the target SoC is raised based on the degree of traffic congestion level being low.

19. The vehicle of claim 17, wherein the at least one instruction, when executed by the processor communicating with the memory, is configured to cause the vehicle to determine a starting point of the second section where an estimated driving time remaining to the destination equals a time required to charge the battery from a current SoC of the battery to the target SoC of the battery.

20. The vehicle of claim 17, wherein the at least one instruction, when executed by the processor communicating with the memory, is configured to cause the vehicle to automatically execute, without driver input, a first output distribution strategy in the first section and a second output distribution strategy in the second section.
